(19) United States
(12) Patent Application Publication
(10) Pub. No.: US 2011/0270744 A1
(43) Pub. Date: Nov. 3, 2011

(54) MOBILE TANGIBLE VALUE BANKING SYSTEM

(76) Inventors: Ginger Baker, San Francisco, CA (US); In-Tchang Kim, Singapore (SG); Ashish Kulpati, Gurgaon (IN); Rachel Bale, London (GB); Joseph Gordon Cooper, Singapore (SG); Sachin Bountra, Dubai (AE); Bharatkumar Patel, Dubai (AE)

(21) Appl. No.: 13/089,162

(22) Filed: Apr. 18, 2011

Related U.S. Application Data
(60) Provisional application No. 61/330,265, filed on Apr. 30, 2010.

(51) Int. Cl. G06Q 40/00

(52) U.S. Cl. 705/39

(57) ABSTRACT

A mobile tangible value banking system is disclosed. A mobile tangible value banking system enables a consumer entity to make a withdrawal from or deposit to their bank account by physically exchanging tangible value with a banking agent and correspondingly verifying the deposit or withdrawal using a mobile device. The consumer entity and the banking agent may be mobile and free to meet in a predetermined location, which may allow banking services to enter remote areas of emerging markets.

### CROSS-REFERENCES TO RELATED APPLICATIONS

The present non-provisional application claims the benefit under 35 U.S.C. §119(e) of U.S. Provisional Patent Application No. 61/330,265, entitled “BUNDLED SERVICE OFFERING,” filed Apr. 30, 2010, the entire disclosure of the referenced application is incorporated herein by reference in its entirety for all purposes.

### BACKGROUND

Numerous infrastructural challenges have made it difficult for banking services and electronic payment systems to be offered to populations in emerging market. The cost of physical distribution sites, such as ATM machines and bank branches, inhibit the spread of banking services to many areas of emerging markets. Consumers living in rural or geographically remote regions especially may not have convenient access to banking services. Moreover, the cost of hardware and supporting infrastructure, such as point of sale terminals and dedicated land lines, may not be economically feasible for merchants in emerging markets. Such difficulties are often compounded by the lack of reliable power, network connectivity, and long standing business habits, such as a preference for face to face dealings, which further delay the expansion of banking services into emerging markets. However, mobile phones are common in emerging markets and wireless access to communications networks may reach remote areas.

Thus, there is a need in the art for mobile tangible value banking system that addresses the above concerns. Embodiments of the invention address these and other problems, individually and collectively.

### BRIEF SUMMARY

Embodiments of the invention disclosed herein include systems, technical architecture of the systems, and methods for a mobile tangible value banking system. A mobile tangible value banking system can be implemented using one or more computer apparatuses and databases.

One embodiment of the invention is directed to a method for receiving a transaction initiation message comprising a consumer entity identifier, a transfer amount, a banking agent identifier and a banking agent passcode from a banking agent associated with the banking agent identifier, validating the banking agent passcode, sending a transaction validation message comprising the transfer amount to a consumer entity associated with the consumer entity identifier, receiving from the consumer entity a transaction confirmation message confirming the transaction amount, sending the banking agent identifier, the consumer identifier, and the transfer amount to a payment processing network, wherein the payment processing network transfers at least the transfer amount between a banking agent issuer and a consumer entity issuer, and sending a completion message to each of the banking agent and the consumer entity, wherein the transfer between the banking agent issuer and consumer entity issuer is reversed if a completion confirmation message is not received from the consumer entity.

Another embodiment of the invention is directed to a method wherein the payment processing network debits at least the transfer amount from the banking agent issuer and credits at least the transfer amount to the consumer entity issuer.

One embodiment of the invention is directed to a method wherein the payment processing network credits at least the transfer amount to the banking agent issuer and debits at least the transfer amount from the consumer entity issuer.

One embodiment of the invention is directed to a method wherein the confirmation message and the completion confirmation message both further comprise a consumer entity passcode which is validated.

One embodiment of the invention is directed to a method wherein the consumer entity provides at least the transfer amount to the banking agent in cash.

Further details regarding embodiments of the invention are provided below in the Detailed Description, Claims, and Figures.

### BRIEF DESCRIPTION OF THE DRAWINGS

FIG. 1 is a mobile tangible value banking system, according to an example embodiment.

FIG. 2 is a block diagram of the modules of a mobile tangible value banking system, according to an example embodiment.

FIG. 3 is process flow of a deposit within the mobile tangible value banking system, according to an example embodiment.

FIG. 4 is a process flow of a withdrawal within the mobile tangible value banking system, according to an example embodiment.

FIG. 5 is a diagram of a computer apparatus, according to an example embodiment.

### DETAILED DESCRIPTION

Embodiments of the invention are directed to systems, architectures of the systems, and methods for a mobile tangible value banking system.

In certain embodiments, a mobile tangible value banking system enables a consumer entity to make a withdrawal from or deposit to their account by physically exchanging tangible value with a banking agent and correspondingly verifying the deposit or withdrawal using a mobile device. The consumer entity and the banking agent may be mobile and free to meet in a predetermined location, which may allow banking services to enter remote areas of emerging markets. For example, the banking agent may be an individual with a backpack full of money that walks to remove villages and takes deposits and provides withdrawals. The banking agent may also be static, such as being located in a building. For example, the banking agent may be an individual at a local market that provides banking services.

The banking agent and consumer entity may physically exchange tangible value, such as cash, to effectuate a deposit or withdrawal. For example, if the consumer entity wishes to make a deposit then the consumer entity may provide tangible value to the banking entity (e.g., a banking agent). Alternatively, if the consumer entity wishes to make a withdrawal then the banking entity may provide tangible value to the consumer entity.

The banking agent and the consumer entity may operatively communicate with a mobile transaction platform to effectuate a deposit to or withdrawal from the consumer entity account. For example, the consumer entity and the banking agent may communicate with the mobile transaction platform via SMS. The banking agent and consumer entity may provide a passcode to authenticate and may further provide verification to continue with a deposit or withdrawal. After the mobile transaction platform authenticates and receives verification from both the consumer entity and the banking agent, it may send a message to a payment processing network to make the appropriate transfers with the consumer entity issuer and the banking agent issuer to make proper deposits and withdrawals from their respective accounts. For example, if the consumer entity makes a deposit and provides tangible value to the banking agent, then the payment processing network will debit funds from the banking agent account associated with the banking agent issuer and credit funds to the consumer entity account associated with the consumer entity issuer. Correspondingly, if the consumer entity makes a withdrawal and receives tangible value from the banking agent, then the payment processing network will debit value from the consumer entity account associated with the consumer entity issuer and credit value to the banking agent account associated with the banking agent issuer.

The mobile tangible value banking system may also provide various supporting functionality, such as anti-money laundering, alias management, account management, and fee calculation services, among others to be described in detail later in the specification.

In other embodiments, the mobile tangible value banking system receives a transaction initiation message comprising a consumer entity identifier, a transfer amount, a banking agent identifier and a banking agent passcode from a banking agent associated with the banking agent identifier, validates the banking agent passcode, sends a transaction validation message comprising the transfer amount to a consumer entity associated with the consumer entity identifier, receives from the consumer entity a transaction confirmation message confirming the transaction amount, sends the banking agent identifier, the consumer identifier, and the transfer amount to a payment processing network, wherein the payment processing network transfers at least the transfer amount between a banking agent issuer and a consumer entity issuer, and sends a completion message to each of the banking agent and the consumer entity, wherein the transfer between the banking agent issuer and consumer entity issuer is reversed if a completion confirmation message is not received from the consumer entity.

Tangible value may comprise various types of value. As used herein “tangible value” may comprise currencies, e.g., USD, RMB, in the form of bills, coins, or other tangible representations. Tangible value also be a tangible representation of bond, share of stock, options, or other financial instrument. Tangible value may also comprise tangible objects worth a certain value, such as goods or chattel, such as a dozen eggs or a pig. Tangible value may also be physical goods worth digital value, including goods unlocking or representing cell phone minutes, online currencies, digital points, and other digital micro-credits. For example, tangible value may be scratch cards or point of sale activated tokens that provide Facebook™ Coins or Zynga™ Cash or Coins. In a further embodiment, a tangible value may be a physical representation of a promise or proof of a service, such as a receipt for services rendered or a contact promising to perform a service. In an example embodiment, a tangible value may be a service with a tangible impact, such as sweeping a pile of leaves.

As used herein a “mobile device” may be any portable device capable of sending and receiving information. In an example embodiment, a mobile device may be a portable communications device, a mobile phone, a smart phone, a portable computer, a pager, or other device capable of two-way wireless communications. The mobile device may be a portable device that can communicate with the mobile transaction platform.

A consumer entity may physically interact with a banking agent as part of a deposit or withdrawal. The consumer entity may request a withdrawal or deposit and receive from or provide to the banking agent tangible value, respectively. The consumer entity and the banking agent may physically exchange tangible value. The consumer entity may also provide or communicate to the banking agent a consumer entity identifier and a transfer amount. In a further embodiment, the transfer amount may be the measure of the value of the tangible value provided to or received by the consumer entity. For example, the consumer entity may give the banking agent $10 USD and their phone number and instruct the banking agent to deposit $10 USD into their account. In an example embodiment, the consumer entity may give the banking agent eggs worth $10 USD rather than cash. The transfer amount may be less than the value of the tangible value if the consumer entity pays a fee for utilizing the banking agent, mobile transaction platform, or payment processing network deposit or withdrawal services.

The banking agent may then operatively communicate with the mobile transaction platform via a mobile device. The banking agent may communicate to the mobile transaction platform the consumer entity identifier and the transfer amount. The banking agent may also identify whether to perform a deposit or withdrawal and further communicate a banking agent identifier and a passcode. In an example embodiment, the banking agent communicates with the mobile transaction platform via SMS or interactive voice response (“IVR”). For example, the banking agent may send a SMS message to the mobile transaction platform with the consumer entity phone number of 206-240-8888, their phone number of 206-240-8877, the transfer amount of $10 USD, a passcode of 1234, and instructions to conduct a withdrawal for the consumer entity. In this example, the mobile transaction platform may authenticate the passcode for 206-240-8877 matches the provided passcode. If the provided passcode does not match the passcode associated with the banking agent, then the transaction may be canceled.

After authenticating the banking agent, the mobile transaction platform may communicate to the consumer entity the transfer amount. The mobile transaction platform may also identify whether it was requested to perform a deposit or withdrawal and request the consumer entity to provide a passcode. The mobile transaction platform may communicate with the consumer entity to verify that the transaction was known and requested by the consumer entity. In an example embodiment, the consumer entity communicates with the mobile transaction platform via SMS or interactive voice response (“IVR”). The consumer entity may respond to the mobile transaction platform by confirming the transfer amount and the deposit or withdrawal. The consumer entity may also provide a passcode to authenticate. For example, the mobile transaction platform may send SMS message to the consumer entity with “Do you accept a $10 deposit from 206-240-8877?” The consumer entity may respond with a SMS indicating approval and with a consumer entity passcode. If the provided passcode does not match the passcode associated with the consumer entity, then the transaction may be canceled.

Upon verifying the transaction with the banking agent and the consumer entity, the mobile transaction platform may operate to transfer value between the banking agent account and the consumer entity account. The consumer entity identifier and the banking agent identifier may be a PAN, an alias, an identifier, a phone number, a MSISDN, SIM card data or a mobile device identifier. The identifiers may also be used to resolve a PAN. For example, the consumer entity identifier may be a phone number that the mobile transaction platform may use to look up a consumer entity PAN. In an example embodiment, the consumer entity identifier and the banking agent identifier may be used to determine the consumer entity issuer and the banking agent issuer, respectively.

After determining the issuers, the mobile transaction platform may perform various anti-money laundering, fee determination, and watch-list checks to mitigate risk and fraud and calculate debit and credit amounts. The risk mitigation techniques may be applied to both the consumer entity and banking agent identifiers/PANs. The mobile transaction platform and the payment processing network may operatively communicate to provide supplemental information and to signal acceptance. Messages may be sent to the consumer entity issuer to credit or debit value and further messages may be sent to the banking agent issuer to credit or debit value.

After the value has been properly credited or debited from the banking agent account and the consumer entity account, then confirmation may be sent to banking agent and the consumer entity via their mobile devices. The consumer entity may respond to the confirmation by providing a final verification. If the final verification is not provided by the consumer entity, the previous credit and debit transactions may be reversed.

The mobile tangible value banking system may comprise multiple modules to support banking operations, such as deposits and withdrawals. Such modules may support functionality such as alias management, reporting, anti-money laundering, watch-list, fees determination, notification, and other functions.

The mobile tangible value banking system may facilitate deposits and withdrawals without exposing sensitive information, such as by using an alias, also referred to as a consumer identity alias. As used herein, an “alias” may be an alpha-numeric value, such as a username, and may be static or dynamic. An alias may also comprise Unicode characters or other CJK (Chinese, Japanese, Korean) characters. An alias may be used to identify a sending entity instead of sharing sensitive information, to preserve privacy and reduce the likelihood of fraud. An alias may be associated with one or more portable consumer devices or accounts.

In a further embodiment, an alias may be a verifiable value, such as a phone number or an email address. The alias is verifiable if the alias value may be used to contact a user the alias represents. The user may be contacted for verification purposes. For example, a phone number and an email are verifiable aliases because the alias value indicates a method to contact a user, such as by SMS or email. For example, in a value transfer transaction, the sending entity may send money from the alias “ted@ted.com” rather than by presenting a credit card number.

The consumer entity and the banking agent may also be identified via a primary account number (“PAN,” also known as a printed account number or permanent account number) or other identifier.

### I. Systems

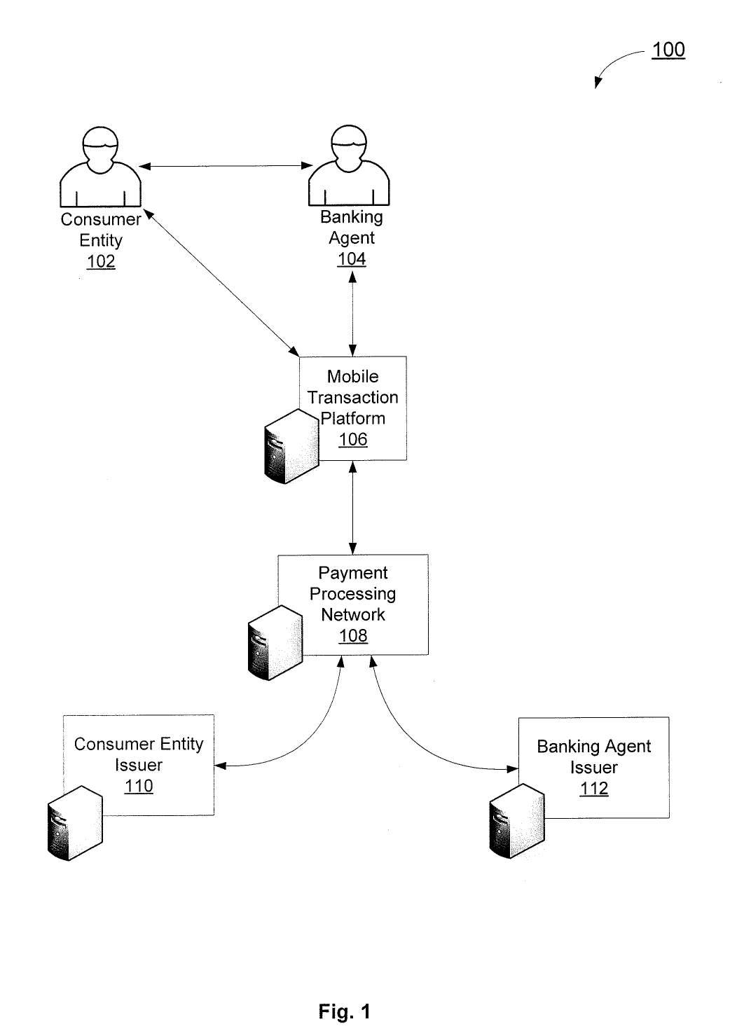

FIG. 1 is a mobile tangible value banking system 100, according to an example embodiment. The mobile tangible value banking system 100 comprises a consumer entity 102, a banking agent 104, a mobile transaction platform 106, a payment processing network 108, a consumer entity issuer 110, and a banking agent issuer 112. Although only one consumer entity 102, one banking agent 104, one mobile transaction platform 106, one payment processing network 108, one consumer entity issuer 110, and one banking agent issuer 112 are shown, there may be any suitable number of any of these entities in the mobile tangible value banking system 100.

The “consumer entity” 102 may be a consumer that is a party to the deposit or withdrawal. The consumer entity 102 may be the entity that makes the withdrawal from or the deposit to their account. The consumer entity 102 may be an individual, an agent, or an organization, such as a business, that is capable of initiating or supporting a deposit or withdrawal with the mobile tangible value banking system 100, and may possess or interact with a mobile device. The consumer entity 102 may physically exchange tangible value with the banking agent 104. For example, the consumer entity 102 may be an individual that provides ten dollars cash to the banking agent 104 and confirms the transaction via a cell phone with the mobile transaction platform 106. The consumer entity 102 may have a consumer entity account with the consumer entity issuer 110. In an example embodiment, the consumer entity account is associated with a portable consumer device. The consumer entity 102 may provide tangible value to the banking agent 104 in a deposit, and may receive tangible value from the banking agent 104 in a withdrawal.

The “banking agent” may be an agent that is a party to the deposit or withdrawal transaction. The banking agent 104 may receive tangible value from the consumer entity 102 in a deposit, and may provide tangible value to the consumer entity 102 in a withdrawal. The banking agent 104 may possess or interact with a mobile device. The banking agent 104 may be an individual, an agent, or an organization, such as a business, that is capable of initiating or supporting a deposit or withdrawal with the mobile tangible value banking system 100. For example, the banking agent 104 may be an individual that provides tangible value to the consumer entity 102 and may interact with the mobile transaction platform 106. The banking agent 104 may have a banking agent account with the banking agent issuer 112. In an example embodiment, the banking agent account is associated with a portable consumer device. For example, a banking agent 104 may be an individual that is mobile and travels to remote locations and may provide banking services, such as taking in deposits and giving out withdrawals, by interacting with the mobile tangible value banking system 100.

As used herein, a “portable consumer device” may be a credit card, a debit card, a mobile phone, a pre-paid card, a mobile application, a payment instrument, a specialized application, or any portable device or software application capable of transferring funds. Such devices may include contact or contactless smart cards, ordinary credit or debit cards (with a magnetic strip and without an embedded microprocessor), keychain devices (such as the Speedpass™ commercially available from Exxon-Mobil Corp.), etc. Other examples of portable consumer devices include cellular phones, personal digital assistants (PDAs), pagers, payment cards, security cards, access cards, smart media, transponders, and the like, where such devices may include an embedded or incorporated contactless chip or similar element.

The mobile transaction platform 106 may be a platform that may interact with the mobile devices of the consumer entity 102 and the banking agent 104. The mobile transaction platform 106 may be a wireless communications provider and may offer communication services via voice, mobile web, internet, and SMS channels. The mobile transaction platform 106 may be capable of receiving an identifier and resolving an associated primary account number. The mobile transaction platform 106 may also register user accounts, such as accounts for the consumer entity 102 and the banking agent 104, and may be able to authenticate the accounts via a registered passcode. The mobile transaction platform 106 may authenticate and verify a deposit or withdrawal with the consumer entity 102 and the banking agent 104 and then communicate with a payment processing network 108 to effectuate a transfer of funds between consumer entity and banking agent accounts.

The mobile transactions platform may comprise a computer apparatus, such as a server computer comprising a processor; and a computer-readable medium coupled to the processor, the computer readable medium comprising code executable by the processor for implementing a method comprising: receiving a transaction initiation message comprising a consumer entity identifier, a transfer amount, a banking agent identifier and a banking agent passcode from a banking agent associated with the banking agent identifier; validating the banking agent passcode; sending a transaction validation message comprising the transfer amount to a consumer entity associated with the consumer entity identifier; receiving from the consumer entity a transaction confirmation message confirming the transaction amount; sending the banking agent identifier, the consumer identifier, and the transfer amount to a payment processing network, wherein the payment processing network transfers at least the transfer amount between a banking agent issuer and a consumer entity issuer; and sending a completion message to each of the banking agent and the consumer entity.

The payment processing network 108 can include a network of suitable entities that have information related to an account associated with the portable consumer device or the consumer entity or banking agent accounts. This information may include data such as profile information, data, aliases, deposit/withdrawal history, metadata, and other suitable information.

The payment processing network 108 may have or operate a server computer and may include a database. The database may include any hardware, software, firmware, or combination of the preceding for storing and facilitating retrieval of information. Also, the database may use any of a variety of data structures, arrangements, and compilations to store and facilitate retrieval of information. The database may store information such a user profile, transfer history, and other deposit/withdrawal related data. The server computer may be coupled to the database and may include any hardware, software, other logic, or combination of the preceding for servicing the requests from one or more client computers. The server computer may use any of a variety of computing structures, arrangements, and compilations for servicing the requests from one or more client computers.

The server computer in the payment processing network can comprise a processor, and a computer readable medium. The computer readable medium can comprise code executable by the processor, for implementing a method comprising: receiving transaction data comprising a banking agent identifier, a consumer entity identifier, and a transfer amount from a mobile transaction platform, wherein the mobile transaction platform received the transaction data from a banking agent associated with the banking agent identifier and confirmed the transaction data with a consumer entity associated with the consumer entity identifier; sending a credit message to a consumer entity issuer to credit at least the transfer amount and sending a debit message to a banking agent issuer to debit at least the transfer amount; and sending a confirmation message to a mobile transaction platform confirming the credit and debit actions succeed, wherein the mobile transaction platform communicates and validates the credit and debit actions with the banking agent and the consumer entity.

The payment processing network 108 may include data processing subsystems, networks, and operations used to support and deliver authorization services, exception file services, and clearing and settlement services. An exemplary payment processing network 108 may include VisaNet™. Networks that include VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. The payment processing network 108 may use any suitable wired or wireless network, including the Internet.

The payment processing network 108 may comprise a mobile tangible value banking application. The mobile tangible value banking application may comprise software modules and supporting hardware that support deposit and withdrawal functionality. For example, the mobile tangible value banking application may comprise modules to manage alias management, notifications, anti-money laundering, etc.

The “consumer entity issuer” 110 may be any suitable entity that may maintain or manage the funds of the consumer entity 102. The consumer entity issuer 110 may have issued, may host, or may manage the portable consumer device or the account of the consumer entity 102 used in the deposit or withdrawal. In an example embodiment, the consumer entity issuer 110 is the issuing bank of the portable consumer device to which funds will be deposited or from which funds will be withdrawn. For example, portable consumer device may be the credit card issued by the consumer entity issuer 110 used to fund a withdrawal. The consumer entity issuer 110 may be a bank, a business entity such as a retail store, or a governmental entity.

The “banking agent issuer” 112 may be any suitable entity that may maintain or manage the funds of the banking agent 104. The banking agent issuer 112 may have issued, may host, or may manage the portable consumer device or the account of the banking agent 104. In an example embodiment, the banking agent issuer 112 is the issuing bank of the portable consumer device from which funds for the banking agent may be withdrawn or deposited to. For example, the banking agent issuer 112 may have issued the credit card receiving the funds in a withdrawal transaction. The banking agent issuer 112 may be a bank, a business entity such as a retail store, or a governmental entity.

The consumer entity 102 may be in operative communication with the banking agent 104. The consumer entity 102 may provide tangible value to the banking agent 104 when making a deposit and may receive tangible value from the banking agent 104 when making a withdrawal. The consumer entity 102 may also provide to the banking agent 104 a consumer entity identifier and a transfer amount. For example, the consumer entity may physically provide tangible value to the banking agent 104 and may communicate verbally to the banking agent 104 their phone number.

The consumer entity 102 and the banking agent 104 may be in operative communication with the mobile transaction platform 106. The consumer entity 102 and the banking agent 104 may communicate with the mobile transaction platform 106 to initiate and provide information for a withdrawal or deposit transaction. The consumer entity 102 and banking agent 104 may also confirm the transaction details, may receive conformation that a deposit or withdrawal was successful, and may authenticate with a passcode and identifier.

The mobile transaction platform 106 may be in operative communication with the payment processing network 108. In an example embodiment, mobile transaction platform 106 communicates with the payment processing network 108 to conduct a withdrawal or deposit. The mobile transaction platform 106 may communicate a consumer entity identifier, a banking agent identifier, a transfer amount, and identify whether a deposit or withdrawal is to be conducted.

The payment processing network 108 may operatively communicate with the consumer entity issuer 110 and the banking agent issuer 112. If a deposit is being made, the payment processing network 108 may communicate with the consumer entity issuer 110 a credit message to credit at least the transfer amount to the consumer entity account, and may communicate with the banking agent issuer 112 a debit message to debit at least the transfer amount from the banking agent account. If a withdrawal is being made, the payment processing network 108 may communicate with the consumer entity issuer 110 a debit message to debit at least the transfer amount from the consumer entity account, and may communicate with the banking agent issuer 112 a credit message to credit at least the transfer amount to the banking agent account. In an example embodiment, the credit message is a original credit transaction (OCT). In a further embodiment, the debit message is an account funding transaction. An account funding transaction (AFT) may be a transaction initiated by a sending entity issuer or payment processing network on behalf of the sending entity that results in the debit of the sending entity's account. An original credit transaction may be a transaction that results in a credit to a recipient entity's account.

An AFT (Account Funding Transaction) can be a transaction designed to supply funds to another account such as a credit, prepaid, debit, ATM or on-line account. An AFT indicator can be used in both the authorization and clearing and settlement transactions. The following fields can be used for an AFT and can be supported in messages and clearing and settlement transactions. They can include: Processing Code; Merchant Type; CAVV Result Code; Mail Order/Telephone Order/Electronic Commerce Indicator; Mail/Phone/Electronic Commerce Indicator; Transaction ID (XID); and TransStain/CAVV Data.

An OCT (Original Credit Transaction) is typically a clearing and settlement credit transaction designed for use in business applications. The OCT can follow a conventional transaction flow. A special indicator can identify an OCT to a bank.

Communications between entities in the mobile tangible value banking system 100 may be conducted via any combination of the web, a mobile network, an intranet, SMS/IVR, a plain old telephone system, email, USSD-2, APIs, tailored messages, a specialized application, or a communications network.

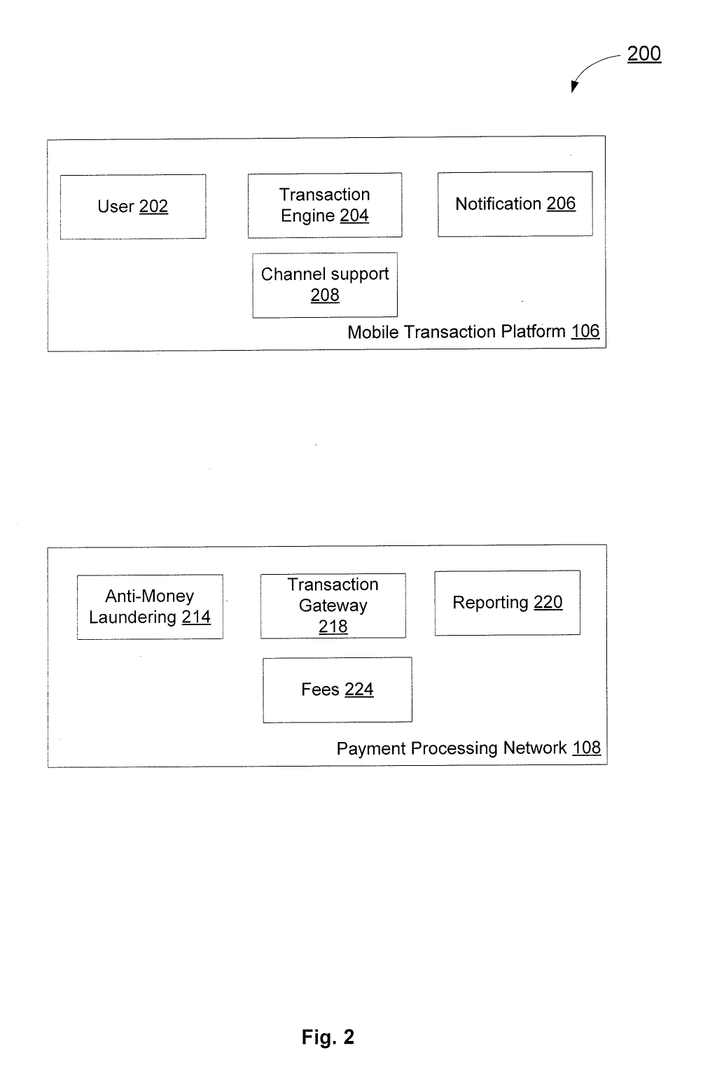

FIG. 2 is a more detailed block diagram of an mobile transaction platform and a payment processing network 200, according to an example embodiment. The mobile transaction platform 106 and the payment processing network 108 may comprise various functional modules which provide deposit and withdrawal services. The mobile transaction platform 106 may comprise user 202, transaction engine 204, notification 206, and channel support 208 modules. The payment processing network 108, potentially as part of a mobile tangible value banking application, may comprise a anti-money laundering 214, transaction gateway 218, reporting 220, and fees 222 modules.

The user module 202 may identify and authenticate a user account associated with the mobile transaction platform. The user module 202 may take as input a user identifier and a passcode and verify if the input matches pre-existing registered data associated with the account. The user module 202 may also take in a user identifier and resolve a PAN associated with the account. For example, the consumer entity 102 may send their phone number and passcode to the mobile transaction platform 106. The user module 202 may then look up the phone number and verify that the provided passcode matches.

The transaction engine module 204 may support messaging flows and gateway functionality supporting the deposits and withdrawals. The transaction engine module 204 may comprise logic to determine when to send messages to users. The transaction engine module 204 may determine when to send authentication and verification messages.

The notification module 206 may notify users of deposits, withdrawals, account changes, and general notices and updates. The notifications module 206 may comprise plug-ins that send notifications through various channels. The notification module 206 may operate with the channel support module 208. In an example embodiment, notification module 206 may send messages via email or SMS. In an example embodiment, the notification module 206 operatively communicates with banking agent 104 and the consumer entity 102.

The channel support module 208 supports multiple communication channels. The channel support module 208 may allow the mobile transaction platform 106 to communicate via multiple channels. The channels supported may comprise mobile phone, internet, physical branch location, and ATM/kiosk. Other channels may include SMS, CSR/IVR, a plain old telephone system, USSD-2 or via a phone bank.

The anti-money laundering (“AML”) module 214 may provide blacklist checks, blocked BIN/PAN checks, and value and velocity checks. The blacklist check function may determine if an identified user is named on certain blacklists or watch lists. In an example embodiment, the blacklist check function takes as an input parameter a user identifier. The AML module 214 may then determine if the user identifier is present on any blacklist. Example blacklists may include the Office of Foreign Asset Control Specially Designed Nationals list. The function may return whether or not the identifier was found on a blacklist. The functions may also use “know your consumer” data supporting anti-money laundering checks. The checks may be conducted on both the consumer entity 102 and banking agent 104 identifier. In an example embodiment, the anti-money laundering module 214 creates an AML and fraud score, based upon various data points including transaction history of both consumer entity 102 and banking agent 104, and may provide the score to issuers. The score may also be an indication of risk, for which a threshold may be defined. The score may also be used by the anti-money laundering module 214 to determine whether to allow the deposit/withdrawal.

A blocked BIN/PAN check may determine if a recipient entity BIN or PAN appears on certain blacklists. In an example embodiment, the blocked BIN/PAN check takes as input the consumer entity and banking agent BIN or PAN and determines if it exists on any blacklist or if it is blocked. The check may return whether or not the consumer entity or banking agent's BIN/PAN was found on a blacklist. The blacklists may be created by issuers or derived from data from credit agencies or other payment processing networks.

The value and velocity checks may determine if the velocity or value of transactions exceeds a certain threshold, so as to likely indicate fraud. In an example embodiment, the value and velocity checks take as input parameters the transfer amount, the consumer entity PAN or alias, a transaction history, and the banking agent PAN or alias. The velocity checks may determine if the number of transactions from a consumer entity within a given time period exceeds a threshold. For example, there may be a velocity limit of six deposits or withdrawals per day, so that if a consumer entity conducts more than six deposits or withdrawals within a day then the velocity check fails. Value checks may determine if the amount of value transferred from a consumer entity within a given time period exceeds a threshold. For example, there may be a value limit of $10,000 USD per week, so that transactions from a consumer entity that cause the consumer entity to exceed $10,000 USD in a week may fail the check. More than one value or velocity check may be applicable simultaneously. Value checks may also be applied to single transactions. In an example embodiment, there may be a maximum and minimum transaction limit. For example, there may be a $10 minimum and a $1,000 maximum for deposit or withdrawal.

The transaction gateway module 218 may support messaging flows and gateway functionality supporting the processing of deposits or withdrawals. In an example embodiment, the transaction gateway 218 operatively communicates with issuers to send credit and debit messages. These messages may be original credit transaction messages and account funding transaction messages. The credit and debit messages may be modified to contain specific information to support the value transfer, such as alias and issuer information. In an example embodiment, if the deposit or withdrawal fails, an AFT reversal may be sent to unwind the value transfer. In an example embodiment, an original credit transaction message and an original credit transaction message may comprise a processing code, a transaction code, a transaction code qualifier, a business application identifier, and a merchant category code. The processing code may be a 26 bit code containing payment processing network 108 data. The transaction code may be a 6 bit code describing a BASE II transaction. The business application identifier may be two bits, and describe either a merchant initiated or bank initiated OCT/AFT.

The reporting module 220 may provide reports on deposits and withdrawals. The reporting module 220 may provide summary reports on a daily, weekly, monthly, or a user set time interval. The summary reports may summarize the deposits and withdrawals. The summary reports may comprise data describing the total number of debit and credit transactions. The summary reports may be broken down into the currency type (e.g., USD), the destination country, and the amount transferred. The summary reports may also describe the number of declined deposits and withdrawals, the number of reversals, and other statuses. The reporting module 220 may also produce detailed reports. The detailed reports may provide information on an individual deposit or withdrawal level, such as reporting the transaction ID, the date, the currency type, and the transaction amount. Reports on the transactions denied, charged back, settled, and approved but not settled may also be produced.

The fees module 224 calculates fees for deposits and withdrawals. The fees module 224 may determine fees by determining fees for different corridors, payment instruments, and applying valid incentives. The fees module 224 may also look into the settings of issuers and the mobile transaction platform 106 to see if addition fees are to be applied. The fees module 224 may also calculate national tariffs, taxes, surcharges, and other charges on transactions. In an example embodiment, the fees may be a domestic fixed amount or domestic transaction percentage. For example, the mobile transaction platform may charge a fixed fee amount of $1 USD per deposit/withdrawal, or a 1% of the transaction fee.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The term “hardware module” can be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

### II. Method

### A. Deposit

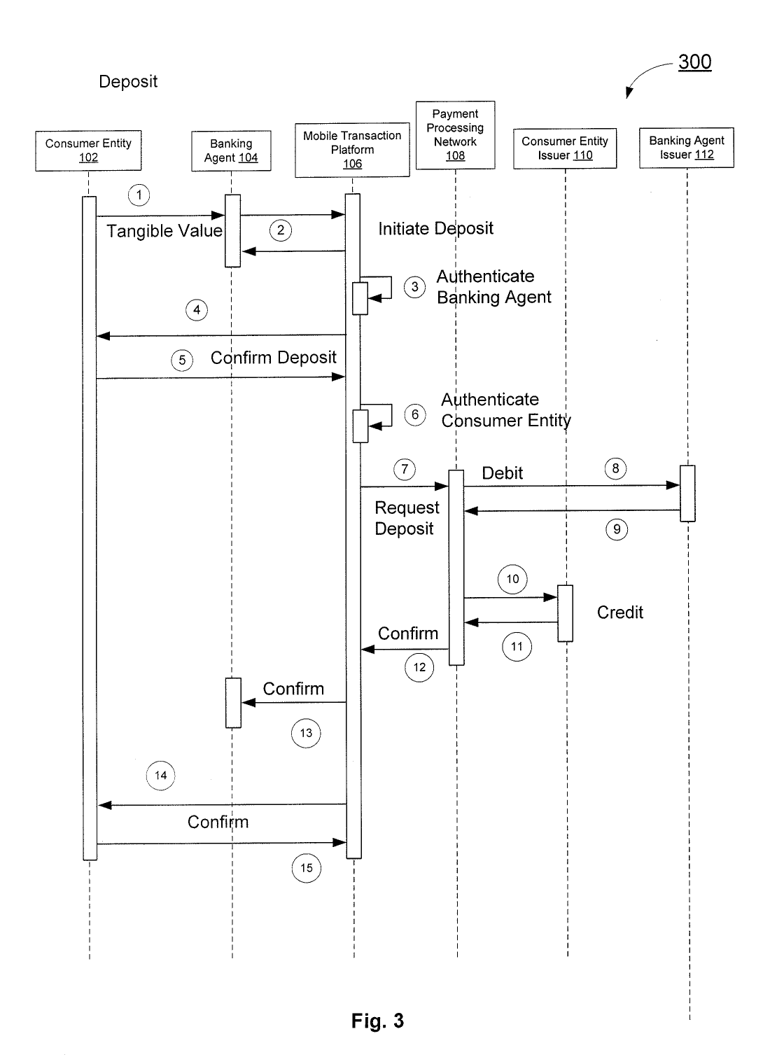

FIG. 3 is process flow of a deposit within the mobile tangible value banking system 300, according to an example embodiment. At operation 1, the consumer entity 102 interacts with the banking agent 104. The consumer entity 102 may communicate with the banking agent 104 in person, verbally, via SMS, email or other communications network. The consumer entity 102 may communicate a transfer amount and a consumer entity identifier to the banking agent 104 and indicate that they wish to perform a deposit. The consumer entity 102 may also give the banking agent 104 tangible value. The consumer entity 102 may physically deliver or cause to be delivered the tangible value to the banking agent 104 or an agent of the banking agent 104. In an example embodiment, the consumer entity identifier may be an alias, as opposed to a PAN, for security or convenience factors. For example, the consumer entity 104 may meet a banking agent 104 in person and physically deliver $10 USD in cash and tell the banking agent 104 to deposit $10 USD into their account associated with the phone number 206-240-8888. The transfer amount may be less than the value of the tangible value due to fees.

Upon receiving the information and tangible value in operation 1 from the consumer entity 102, the banking agent 104 may analyze the received information and at operation 2, may operatively communicate with the mobile transaction platform 106 to initiate a deposit. The banking agent 104 may indicate to the mobile transaction platform 106 that a deposit can be made. The data may be sent via a transaction initiation message. The banking agent 104 may also communicate the consumer entity identifier, a banking agent identifier, the transfer amount, and a passcode. For example, the banking agent 104 could send a SMS message to the mobile transaction platform 106 with a particular code, such as “*100#,” indicating a mobile tangible value banking transaction. The mobile transaction platform 106 may respond with a SMS indicating the options of making a deposit or withdrawal. The banking agent 104 could respond to the mobile transaction platform 106 with a SMS indicating it wishes to make a deposit. The mobile transaction platform 106 may then request the banking agent's 104 passcode, the consumer entity identifier, and a transfer amount. The banking agent 104 may then respond to the mobile transaction platform 106 with the consumer entity identifier, a passcode, and a transfer amount via SMS.

At operation 3, the mobile transaction platform 106 authenticates the banking agent 104. The mobile transaction platform 106 (or a server computer operating therein) may analyze the banking agent identifier and the provided passcode, potentially using the user module, to see if the passcode matches. After authenticating the banking agent 104, the mobile transaction platform 106 may then communicate with the consumer entity 102 to verify the deposit with and authenticate the consumer entity 102.

At operation 4, the mobile transaction platform 106 may communicate with the consumer entity 102 with details of the proposed deposit and asking for verification. The mobile transaction platform 106 may communicate the data via a transaction validation message. For example, the mobile transaction platform 106 may send a SMS message comprising of the transfer amount, indicating a deposit, and asking for the consumer entity 102 passcode.

The consumer entity 102 may respond with a message confirming the deposit and also providing a passcode at operation 5. The message may be a transaction confirmation message. At operation 6, the mobile transaction platform 106 authenticates the consumer entity 102. The mobile transaction platform 106 may analyze the consumer entity identifier and the provided passcode to see if the passcode matches. In an example embodiment, the consumer entity identifier and the banking agent identifier may identify an account in the mobile transaction platform 106, such as a mobile phone account, with an associated passcode created during registration that can be compared against a passcode provided during the deposit.

After verifying the deposit with the authenticated consumer entity 102 and the banking agent 104, the mobile transaction platform 106 at operation 7 then communicates with the payment processing network 108 to effectuate the proper transfer of value. The mobile transaction platform 106 may send a deposit request message to the payment processing network 108 comprising the banking agent identifier, the consumer entity identifier, the transfer amount, and a transaction type indicator indicating a deposit. The payment processing network 108 may receive the deposit request message and may analyze the banking agent identifier and the consumer entity identifier to resolve respective PANs. For example, the payment processing network 108 may analyze a provided phone number or alias and resolve a PAN. The payment processing network 108 may also perform various anti-money laundering and velocity checks. The payment processing network 108 may use the functionality of the anti-money laundering module to analyze the consumer entity 102, the banking agent 104, and the deposit or withdrawal as a whole.

At operation 8, the payment processing network 108 may operatively communicate a debit message with the banking agent issuer 112 to debit at least the transfer amount. The payment processing network 108 may specify the banking agent account via the PAN resolved using the banking agent identifier. In an example embodiment, the debit message is an account funding transaction. If the banking agent issuer 112 successfully debits at least the transfer amount from the banking agent account, then at operation 9 the banking agent issuer 112 sends a debit confirmation message to the payment processing network 108.

After receiving the debit confirmation message from the banking agent issuer 112, the payment processing network 108, at operation 10, may send a credit message to the consumer entity issuer 110. In an example embodiment, the credit message is an original credit transaction. The credit message may instruct the consumer entity issuer 110 to credit at least the transfer amount to the consumer entity account. If the credit fails, the previous debit transaction with the banking agent issuer 112 may be unwound, such as by an AFT reversal. If the consumer entity issuer 110 successfully credits the consumer entity account, then at operation 11, the consumer entity issuer 110 sends a credit confirmation message to the payment processing network 108 indicating that the credit was successful.

After receiving the confirmation messages, the payment processing network 108, may at operation 12, send a confirmation message to the mobile transaction platform indicating that the transfers between the consumer entity 102 and banking agent 104 accounts were successful. At operation 13, the mobile transaction platform 106 may communicate to the banking agent 104 that the transfers between the banking agent account and the consumer entity account were successful. Furthermore, at operation 14 the mobile transaction platform 106 may send a confirmation message (an example of a completion message) to the consumer entity 102 indicating that the transfers between the banking agent account and the consumer entity account were successful and asking for final confirmation.

At operation 15, after receiving the confirmation message (an example of a completion message) from the mobile transaction platform 106, the consumer entity 102 may send a final confirmation message to the mobile transaction message with a passcode. The final confirmation message may represent that the physical exchange of tangible value occurred between the consumer entity 102 and the banking agent 104. In an example embodiment, if the consumer entity 102 does not provide a final confirmation message within a predetermined amount of time, or sends a message denying the transfer, then the debit and credit transactions between the consumer entity issuer 110 and the banking agent issuer 112 may be reversed. This is desirable, because the consumer entity 102 preferably verifies both the start and the finish of the transaction to confirm that the transaction is to proceed to completion. If the consumer entity 102 does not provide this verification, then the system may have erroneously transferred funds, thereby causing greater problems at a later date.

### B. Withdrawal

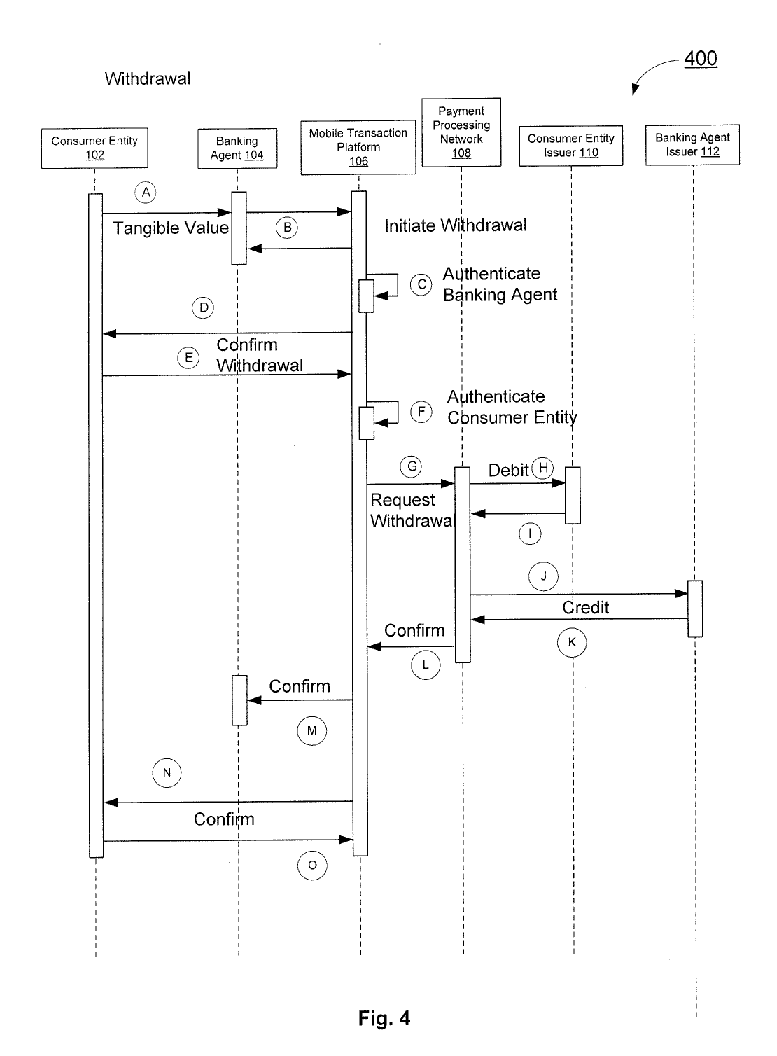

FIG. 4 is process flow of a withdrawal within the mobile tangible value banking system 400, according to an example embodiment. At operation A, the consumer entity 102 interacts with the banking agent 104. The consumer entity 102 may communicate with the banking agent 104 in person, verbally, via SMS, email or other communications network. The consumer entity 102 may communicate a transfer amount and a consumer entity identifier to the banking agent 104 and indicate that they wish to perform a withdrawal. The consumer entity 102 may also receive from the banking agent 104 tangible value. The consumer entity 102 may physically receive the tangible value from the banking agent 104 or an agent of the banking agent 104. In an example embodiment, the consumer entity identifier may be an alias, as opposed to a PAN, for security or convenience factors. For example, the consumer entity 104 may meet a banking agent 104 in person and tell the banking agent 104 to withdrawal $10 USD from their account associated with the phone number 206-240-8888 and physically receive $10 USD in cash.

Upon receiving the information and providing the tangible value in operation A, the banking agent 104 may analyze the received information and at operation B, may operatively communicate with the mobile transaction platform 106 to initiate a withdrawal. The data may be sent via a transaction initiation message. The banking agent 104 may indicate to the mobile transaction platform 106 that a withdrawal should be made. The banking agent 104 may also communicate the consumer entity identifier, a banking agent identifier, the transfer amount, and a passcode. For example, the banking agent 104 could send a SMS message to the mobile transaction platform 106 with a particular code, such as “*100#,” indicating a mobile tangible value banking transaction. The mobile transaction platform 106 may respond with a SMS indicating the options of making a deposit or withdrawal. The banking agent 104 could respond to the mobile transaction platform 106 with a SMS indicating it wishes to make a withdrawal. The mobile transaction platform 106 may then request the banking agent's 104 passcode, the consumer entity identifier, and a transfer amount. The banking agent 104 may then respond to the mobile transaction platform 106 with the consumer entity identifier, a passcode, and a transfer amount via SMS.

At operation C, the mobile transaction platform 106 authenticates the banking agent 104. The mobile transaction platform 106 may analyze the banking agent identifier and the provided passcode, potentially using the user module, to see if the passcode matches. After authenticating the banking agent 104, the mobile transaction platform 106 may then communicate with the consumer entity 102 to verify the withdrawal with and authenticate the consumer entity 102.

At operation D, the mobile transaction platform 106 may communicate with the consumer entity 102 with details of the proposed withdrawal and asking for verification. The mobile transaction platform 106 may communicate the data via a transaction validation message. For example, the mobile transaction platform 106 may send a SMS message comprising of the transfer amount, indicating a withdrawal, and asking for the consumer entity 102 passcode.

The consumer entity 102 may respond with a message confirming the withdrawal and also providing a passcode at operation E. The message may be a transaction confirmation message. At operation F, the mobile transaction platform 106 authenticates the consumer entity 102. The mobile transaction platform 106 may analyze the consumer entity identifier and the provided passcode to see if the passcode matches. In an example embodiment, the consumer entity identifier and the banking agent identifier may identify an account in the mobile transaction platform 106, such as a mobile phone account, with an associated passcode created during registration that can be compared against a passcode provided during the withdrawal.

After verifying the withdrawal with the authenticated consumer entity 102 and the banking agent 104, the mobile transaction platform 106 at operation G then communicates with the payment processing network 108 to effectuate the proper transfer of value. The mobile transaction platform 106 may send a withdrawal request message to the payment processing network 108 comprising the banking agent identifier, the consumer entity identifier, the transfer amount, and indicating a deposit. The payment processing network 108 may receive the withdrawal request message and may analyze the banking agent identifier and the consumer entity identifier to resolve respective PANs. For example, the payment processing network 108 may analyze a provided phone number or alias and resolve a PAN. The payment processing network 108 may also perform various anti-money laundering and velocity checks. The payment processing network 108 may use the functionality of the anti-money laundering module to analyze the consumer entity 102, the banking agent 104, and the withdrawal as a whole.

At operation H, the payment processing network 108 may operatively communicate a debit message with the consumer entity issuer 110 to debit at least the transfer amount. The payment processing network 108 may specify the banking agent account via the PAN resolved using the banking agent identifier. In an example embodiment, the debit message is an account funding transaction. If the consumer entity issuer 110 successfully debits at least the transfer amount from the consumer entity account, then at operation I the consumer entity issuer 110 sends a debit confirmation message to the payment processing network 108.

After receiving the debit confirmation message from the consumer entity issuer 110, the payment processing network 108, at operation J, may send a credit message to the banking agent issuer 112. In an example embodiment, the credit message is an original credit transaction. The credit message may instruct the banking agent issuer 112 to credit at least the transfer amount to the banking agent account. If the credit fails, the previous debit transaction with the consumer entity issuer may be unwound, such as by an AFT reversal. If the banking agent issuer 112 successfully credits the banking agent account, then at operation K, the banking agent issuer 112 sends a credit confirmation message to the payment processing network 108 indicating that the credit was successful.

After receiving the confirmation messages, the payment processing network 108, may at operation L, send a confirmation message to the mobile transaction platform indicating that the transfers between the consumer entity 102 and banking agent 104 accounts were successful. At operation M, the mobile transaction platform 106 may communicate to the banking agent 104 that the transfers between the banking agent account and the consumer entity account were successful (an example of a completion message). Furthermore, at operation N the mobile transaction platform 106 may send a confirmation message to the consumer entity 102 indicating that the transfers between the banking agent account and the consumer entity account were successful and asking for final confirmation (an example of a completion message).

At operation O, after receiving the confirmation message from the mobile transaction platform 106, the consumer entity 102 may send a final confirmation message to the mobile transaction message with a passcode. The final confirmation message may represent that the physical exchange of tangible value occurred between the consumer entity 102 and the banking agent 104. In an example embodiment, if the consumer entity 102 does not provide a final confirmation message within a predetermined amount of time, or sends a message denying the transfer, then the debit and credit transactions between the consumer entity 110 issuer and the banking agent issuer 112 may be reversed.

Embodiments of the mobile tangible value banking system may provide several advantages over existing systems. The mobile tangible value banking system allows banking services, such as withdrawals and deposits, to be delivered to populations in emerging markets where banking infrastructure may not exist or be convenient. It provides a technically secure solution to deposits using common mobile phone technology. It avoids or overcomes other technical difficulties in emerging markets, such as power and network outages. Further, embodiments of the invention are more secure and reliable the conventional banking systems, because various checks and confirmations between the various parties to the transactions can be performed quickly and in near real time.

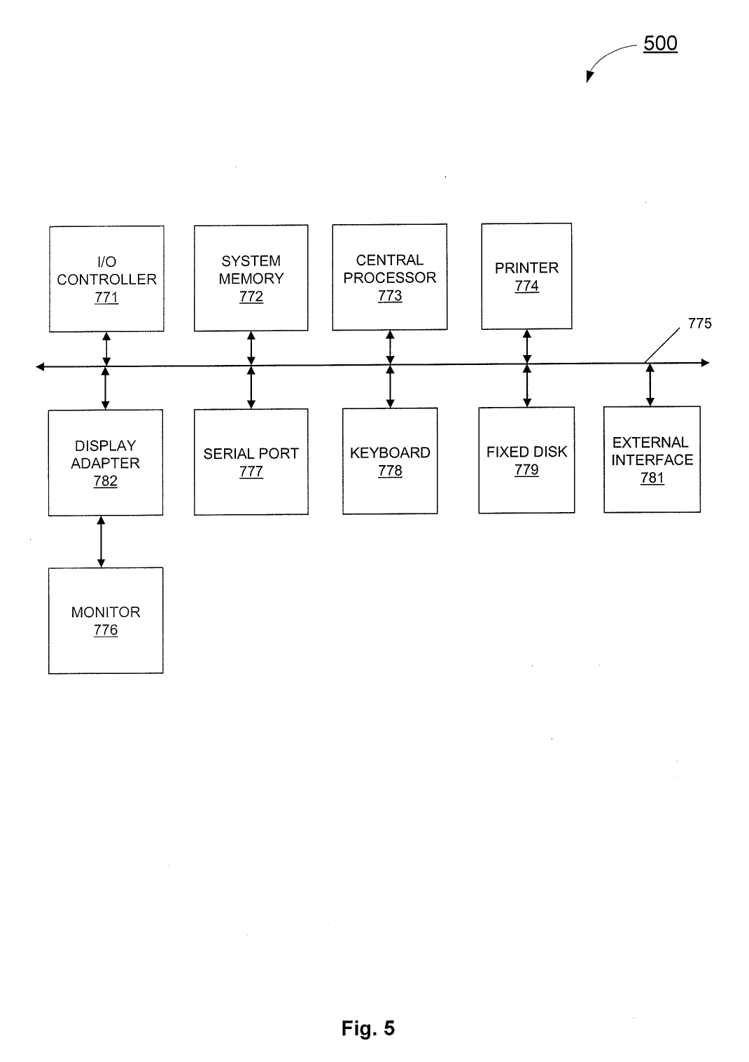

FIG. 5 is a diagram of a computer apparatus, according to an example embodiment. The various participants and elements in the previously described system diagrams (e.g., the mobile transaction platform, payment processing network, etc. in FIGS. 1, 2, 3, 4) may use any suitable number of subsystems in the computer apparatus to facilitate the functions described herein. Examples of such subsystems or components are shown in FIG. 5. The subsystems shown in FIG. 5 are interconnected via a system bus 775. Additional subsystems such as a printer 774, keyboard 778, fixed disk 779 (or other memory comprising computer-readable media), monitor 776, which is coupled to display adapter 782, and others are shown. Peripherals and input/output (I/O) devices, which couple to I/O controller 771, can be connected to the computer system by any number of means known in the art, such as serial port 777. For example, serial port 777 or external interface 781 can be used to connect the computer apparatus to a wide area network such as the Internet, a mouse input device, or a scanner. The interconnection via system bus allows the central processor 773 to communicate with each subsystem and to control the execution of instructions from system memory 772 or the fixed disk 779, as well as the exchange of information between subsystems. The system memory 772 and/or the fixed disk 779 may embody a computer-readable medium.

The software components or functions described in this application may be implemented as software code to be executed by one or more processors using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

The present invention can be implemented in the form of control logic in software or hardware or a combination of both. The control logic may be stored in an information storage medium as a plurality of instructions adapted to direct an information processing device to perform a set of steps disclosed in embodiments of the present invention. Based on the disclosure and teachings provided herein, a person of ordinary skill in the art will appreciate other ways and/or methods to implement the present invention.

In embodiments, any of the entities described herein may be embodied by a computer that performs any or all of the functions and steps disclosed.

Any recitation of “a”, “an” or “the” is intended to mean “one or more” unless specifically indicated to the contrary.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

What is claimed is:

1. A method comprising:
receiving a transaction initiation message comprising a consumer entity identifier, a transfer amount, a banking agent identifier and a banking agent passcode from a banking agent associated with the banking agent identifier;
validating the banking agent passcode;
sending a transaction validation message comprising the transfer amount to a consumer entity associated with the consumer entity identifier;
receiving from the consumer entity a transaction confirmation message confirming the transaction amount;
sending the banking agent identifier, the consumer identifier, and the transfer amount to a payment processing network, wherein the payment processing network transfers at least the transfer amount between a banking agent issuer and a consumer entity issuer; and
sending a completion message each of the banking agent and the consumer entity.

2. The method of claim 1, wherein the payment processing network debits at least the transfer amount from the banking agent issuer and credits at least the transfer amount to the consumer entity issuer.

3. The method of claim 1, wherein the payment processing network credits at least the transfer amount to the banking agent issuer and debits at least the transfer amount from the consumer entity issuer.

4. The method of claim 1, wherein the confirmation message and the completion confirmation message both further comprise a consumer entity passcode which is validated.

5. The method of claim 2, wherein the consumer entity provides at least the transfer amount to the banking agent in cash, and wherein the transfer between the banking agent issuer and consumer entity issuer is reversed if a completion confirmation message is not received from the consumer entity.

6. The method of claim 3, wherein the consumer entity receives at least the transfer amount from the banking agent in cash, and wherein the transfer between the banking agent issuer and consumer entity issuer is reversed if a completion confirmation message is not received from the consumer entity.

7. The method of claim 2, wherein the payment processing network sends an account funding transaction message to the banking agent issuer to debit at least the transfer amount and sends an original credit transaction message to the consumer entity issuer to credit at least the transfer amount.

8. The method of claim 3, wherein the payment processing network sends an account funding transaction message to the consumer entity issuer to debit at least the transfer amount and sends an original credit transaction message to the banking agent issuer to credit at least the transfer amount

9. The method of claim 1, wherein the consumer entity identifier is an alias is associated with a consumer entity primary account number.

10. The method of claim 1, wherein the banking agent and consumer entity communicates via SMS.

11. A non-transitory computer readable medium comprising code that when executed by a processor performs the method of claim 1.

12. A method comprising:
receiving transaction data comprising a banking agent identifier, a consumer entity identifier, and a transfer amount from a mobile transaction platform, wherein the mobile transaction platform received the transaction data from a banking agent associated with the banking agent identifier and confirmed the transaction data with a consumer entity associated with the consumer entity identifier;
sending a credit message to a consumer entity issuer to credit at least the transfer amount and sending a debit message to a banking agent issuer to debit at least the transfer amount; and
sending a confirmation message to a mobile transaction platform confirming the credit and debit actions succeed, wherein the mobile transaction platform communicates and validates the credit and debit actions with the banking agent and the consumer entity.

13. The method of claim 12, wherein the consumer entity provides the transfer amount to the banking agent in cash.

14. The method of claim 12, wherein the credit message is an original credit transaction and the debit message is an account funding transaction.

15. The method of claim 12, wherein the consumer entity identifier is an alias is associated with a consumer entity primary account number.

16. The method of claim 12, wherein the credit and debit actions are reversed if the consumer entity fails to send a confirmation message.

17. A non-transitory computer readable medium comprising code that when executed by a processor performs the method of claim 12.

18. A system comprising
a processor; and
a computer-readable medium coupled to the processor, the computer readable medium comprising code executable by the processor for implementing a method comprising:
receiving a transaction initiation message comprising a consumer entity identifier, a transfer amount, a banking agent identifier and a banking agent passcode from a banking agent associated with the banking agent identifier;
validating the banking agent passcode;
sending a transaction validation message comprising the transfer amount to a consumer entity associated with the consumer entity identifier;
receiving from the consumer entity a transaction confirmation message confirming the transaction amount;
sending the banking agent identifier, the consumer identifier, and the transfer amount to a payment processing network, wherein the payment processing network transfers at least the transfer amount between a banking agent issuer and a consumer entity issuer; and
sending a completion message to each of the banking agent and the consumer entity.

19. The method of claim 18, wherein the payment processing network debits at least the transfer amount from the banking agent issuer and credits at least the transfer amount to the consumer entity issuer.

20. The method of claim 18, wherein the consumer entity provides the transfer amount to the banking agent in cash, and wherein the transfer between the banking agent issuer and consumer entity issuer is reversed if a completion confirmation message is not received from the consumer entity.

21. The method of claim 1 wherein the transfer between the banking agent issuer and consumer entity issuer is reversed if a completion confirmation message is not received from the consumer entity.
